(19) United States
(12) Patent Application Publication
(10) Pub. No.: US 2018/0223068 A1
(43) Pub. Date: Aug. 9, 2018

(54) UNVULCANIZED LIQUID OR SOLID SILICONE RUBBER AND METHOD FOR USING LIQUID OR SOLID SILICONE RUBBER IN AN INJECTION METHOD

(71) Applicant: Universität Kassel, Kassel (DE)

(72) Inventors: Lucas Bogedale, Berlin (DE); Ralf Urs Giesen, Mansfeld (DE); Hans-Peter Heim, Guetersloh (DE)

(21) Appl. No.: 15/750,699

(22) PCT Filed: Jul. 29, 2016
(86) PCT No.: PCT/DE2016/100349

§ 371 Date: Feb. 6, 2018

(30) Foreign Application Priority Data
Aug. 7, 2015 (DE) 10 2015 010 380.6

(51) Int. Cl. C08J 9/32; B29C 44/20

(52) U.S. Cl. CPC C08J 9/32; B29C 44/206; B29K 2083/005; C08J 2203/22; C08J 2383/04; C08J 2201/026

(57) ABSTRACT

An unvulcanized liquid or solid silicone rubber containing a proportion of a filler material that expands at an increased temperature.

### CROSS-REFERENCE TO RELATED APPLICATIONS

This application is the U.S. national stage of PCT/EP2016/000751 filed May 9, 2016, which claims priority of European Patent Application 15001921.4 filed Jun. 29, 2015 of which is hereby incorporated by reference in its entirety.

### FIELD OF THE INVENTION

The This invention, relates to a liquid or solid silicone rubber in an unvulcanized state and, in particular, to a method for processing liquid or solid silicone rubber in an injection molding method.

### BACKGROUND OF THE INVENTION

Liquid or solid silicone rubbers are sufficiently known from the prior art. Parts that have to have a high temperature resistance or that also have to be resistant to ultraviolet radiation UV are frequently produced from such silicone rubbers. However, the high price is a disadvantage with silicone rubber materials. The possibilities for use of silicone rubber are manifold, however, so that there is an endeavor to reduce the costs for the use of silicone rubber for the manufacture of the most varied parts.

A method of manufacturing plastic parts, and here in particular plastic sections, is known from the prior art in accordance with EP 1 749 644 A1 in which powder or filler materials are introduced into a granulated thermoplastic carbon material, this mixture is heated, and is shaped into plastic parts. The thermoplastic carbon material is comparatively expensive so that there is an endeavor to reduce the proportion of thermoplastic carbon material with respect to the respective workpiece. The use of filler materials is known for this purpose, and here in particular the use of so-called microspheres. Microspheres are sufficiently known from the prior art and can be purchased, for example, from “AkzoNobel” under the name “Expancel®” microspheres. Such microspheres are spherical plastic spheres that consist of a polymer shell in which a gas is encapsulated. The gas pressure in the interior of the shell increases by heating, with the shell simultaneously softening due to the heat, which results in a volume increase of such microspheres. The propellant, however, remains permanently enclosed in this process. It is now known from the already previously named EP 1 749 644 A1 to process a mixture of thermoplastic carbon material and the previously described microspheres in an injection molding process. In the injection molding process, the mixture of thermoplastic carbon material and the filler material is added in the form of microspheres through a plasticizing unit through a nozzle into a workpiece mold. EP 1 749 644 now starts from the fact that the microspheres already increase their volume within the plasticizing unit due to the temperatures present there and even reach the intended end state with respect to the particle size. A similar process is also described with respect to the manufacture of plastic parts in an extrusion process. In summary, this means that it was assumed in the drafting of EP 1 749 644 A1 that the microspheres should already expand in the plasticizing unit or in the extruder.

The manufacture of a composite rubber material as a shock absorbing material is described in EP 0 186 493 B1, wherein a mixture of silicone rubber and microspheres is provided, with the micro spheres already being admixed to the silicone rubber in the expanded state prior to the further processing, in particular in the following vulcanization.

The manufacture of an insulation material having good insulation properties is known from DE 10 2010 017 305 A1, wherein the insulation material has a closed pore structure due to the use of pre-expanded microspheres.

EP 2 842 992 A2 relates to an insulation material that can be manufactured inexpensively due to a density reduction through the use of microspheres.

US 2008/0200609 A1 describes the manufacture of a two-component silicone rubber having friction-reduced properties.

DE 10 2006 042 687 A1 deals with the manufacture of a silicone rubber foam to which metallic additives are added to generate heat by microwaves.

### SUMMARY OF THE INVENTION

The subject of the invention is now, on the one hand, a liquid or solid silicone rubber in an unvulcanized state and, on the other hand, a method for processing liquid or solid silicone rubber in an injection molding method.

The liquid or solid silicone rubber is frequently injection molded to form silicone rubber molds for further processing.

The underlying object of the invention now comprises providing a liquid or solid silicone rubber in an unvulcanized state that permits the manufacture of inexpensive components and can nevertheless be further processed easily.

It is suggested to achieve the object in accordance with the invention that the liquid or solid silicone rubber has a portion of filler material, in particular the previously mentioned microspheres, in the unvulcanized state that can expand at an elevated temperature. This means that the microspheres are added to the liquid or solid silicone rubber in non-expanded form in the unvulcanized state. It directly follows on from this that it is possible without problem in the further processing of such a mixture of liquid or solid silicone rubber using such microspheres, in particular in an injection molding method or by way of extrusion, since the microspheres have no influence on the further processing due to their diameters of 10 to 40 μm.

The microspheres, that is the filler material expandable at an elevated temperature, comprises a spherical plastic shell in which a propellant is encapsulated, with an enlarging of the volume by 40 to 50 times being able to take place on a corresponding supply of heat and a corresponding time period.

The material of the plastic shell is advantageously in the thermoelastic range at the vulcanization temperature of the liquid or solid silicone rubber and is expandable under the influence of the propellant at the vulcanization temperature. That is, the microspheres increase their volumes.

### DETAILED DESCRIPTION OF THE INVENTION

The subject of the invention is likewise an injection molding method for manufacturing components while processing liquid or solid silicone rubber, wherein a filter material expandable under heat, in particular microspheres, is added to the liquid or solid silicone rubber before the injection of the liquid or solid silicone rubber into the workpiece mold, with the mixture of liquid or solid silicone rubber being kept below the vulcanization temperature and below the expansion temperature of the filler material during the injection procedure and with a heating of the mixture to the vulcanization temperature of the silicone rubber taking place after a filling of the workpiece mold. The vulcanization time and the vulcanization temperature are here advantageously coordinated with the expansion temperature and the expansion time of the microspheres. It becomes clear from this that the microspheres do not yet expand in the plasticizing unit of the injection molding machine. The expansion of the microspheres and thus the increase of the pore volume or reduction of the density of the mixture only takes place in the workpiece mold. This has the great advantage, however, that there are in principle no limits to the expansion of the microspheres in the workpiece mold. The volumes of the microspheres can increase by 40 to 50 times in the workpiece mold. Provision is also made to this extent that the mixture of liquid or solid silicone rubber is injected into the workpiece mold in a low volumetric amount, that is the degree of filling of the workpiece mold is approximately at 50 to 90%. The advantage of the described procedure is that damage to the microspheres is almost precluded on the processing in the plasticizing unit. This is in contrast to if the microspheres were already to be introduced into the plasticizing units in an expanded state since there is then a risk that the microspheres are damaged in the expanded state in the plasticizing unit. This does not only apply during the dwell time of the microspheres in the actual plasticizing unit, but in particular also on the passage through the nozzle at the tip of the plasticizing unit into the workpiece mold. For the nozzle has a diameter of approximately 400 μm, which hinders the passage of fully expanded microspheres through the nozzle and can lead to damage to the microspheres.

It is now, however, by all means the case that there is an endeavor to increase the portion of high-volume microspheres in the end product, e.g. in the component or workpiece. For it has been found that the increase of the volume size of the microspheres in the workpiece is accompanied by an improvement in the elasticity, in particular with regard to a smaller pressure deformation residue and a higher impact resilience.

The improvement in the elasticity is thus only possible in the processing of liquid or solid silicone rubber in the injection molding process when the expansion of the microspheres in the liquid or solid silicone rubber only takes place in the workpiece mold and not already in the plasticizing unit because the mixing in of already expanded microspheres produces an increase in the viscosity of the material and thus in higher shear forces in the processing. To prevent damage to the microspheres in the processing, only a small portion of already expanded microspheres can be worked into the liquid or solid silicone rubber.

A greater portion of filler material can be mixed into the liquid or solid silicone rubber due to the use of expandable microspheres so that an improvement of the elasticity and a significant reduction of the density can be achieved.

The subject of the invention is furthermore the use of a liquid or solid silicone rubber, for manufacturing a component or workpiece in an injection molding process. cm 1.-10. (canceled)

11. A liquid or solid silicone rubber composition, comprising:
a liquid or solid silicone rubber in an unvulcanized state; and
a portion of filler material expandable at an elevated temperature.

12. The liquid or solid silicone rubber composition of claim 11, wherein the filler material comprises microspheres.

13. The liquid or solid silicone rubber composition of claim 12, wherein the microspheres have a spherical plastic shell in which a propellant is encapsulated.

14. The liquid or solid silicone rubber composition of claim 13, wherein the spherical plastic shell of the microspheres comprise a material that is in a thermoelastic range at a vulcanization temperature of the liquid or solid silicone rubber and is expandable under the influence of the propellant at the vulcanization temperature.

15. An injection molding method for processing a liquid or solid silicone rubber, comprising:
providing a filler material that is expandable under heat;
providing a liquid or solid silicone rubber;
adding the liquid or solid silicone rubber to the filler material to form a mixture;
adding the mixture into a material mold for an injection procedure, the mixture of the liquid or solid silicone rubber and the filler material being expandable under heat;
keeping the mixture below a vulcanization temperature and below an expansion temperature of the filler material prior to the injection procedure; and
injecting the mixture into a workpiece mold during the injection procedure, filling the workpiece mold with the mixture and heating the mixture to the vulcanization temperature of liquid or solid silicone rubber.

16. The injection molding method of claim 15, wherein the filler material comprises microspheres.

17. The injection molding method of claim 15, wherein the mixture is introduced into the workpiece mold in a low volumetric amount.

18. The injection molding method of claim 17, wherein the workpiece mold is filled between 50 and 90% with the mixture.

19. The injection molding method of claim 16, wherein a vulcanization time and the vulcanization temperature of the liquid or solid silicone rubber are coordinated with an expansion temperature and an expansion time of the microspheres.

20. A method of injection molding a component or workpiece using a liquid or solid silicone rubber composition, comprising:
providing a liquid or solid silicone rubber composition having a liquid or solid silicone rubber in an unvulcanized state and a portion of filler material expandable at an elevated temperature; and
injection molding a component or workpiece using the liquid or solid silicone rubber composition.

21. The method of injection molding in accordance with claim 20, wherein the portion of filler material comprises microspheres.

22. The method of injection molding in accordance with claim 21, wherein the microspheres have a spherical plastic shell in which a propellant is encapsulated.

23. The method of injection molding in accordance with claim 22, wherein the spherical plastic shell of the microspheres comprise a material that is in a thermoelastic range at a vulcanization temperature of the liquid or solid silicone rubber and is expandable under the influence of the propellant at the vulcanization temperature.
